(19) United States
(12) Patent Application Publication
(10) Pub. No.: US 2010/0093104 A1
(43) Pub. Date: Apr. 15, 2010

(54) Method and apparatus for positioning nano-particles

(75) Inventors: Kwai Hung Lam, New South Wales (AU); Wenrong Yang, New South Wales (AU)

Correspondence Address: NIXON & VANDERHYE, PC, 901 NORTH GLEBE ROAD, 11TH FLOOR, ARLINGTON, VA, 22203, US

(73) Assignee: Commonwealth Scientific and Industrial Research Organization, Campbell (AU)

(21) Appl. No.: 12/311,693

(22) PCT Filed: Oct. 9, 2007
(86) PCT No.: PCT/AU2007/001527

§ 371 Date: Oct. 9, 2009

(30) Foreign Application Priority Data
Oct. 9, 2006 (AU) 2006905605

(51) Int. Cl. G01N 27/416; G01N 27/72

(52) U.S. Cl. 436/151; 422/68.1; 977/773; 977/933; 977/838

(57) ABSTRACT

A method of positioning a sample at a desired location relative to a magnetic sensor, for measurement of magnetic characteristics of the sample. A sample mounting substrate is provided, and an amphifunctional molecule is bound to the sample mounting substrate at the desired location. The amphifunctional molecule has a portion for binding to the sample mounting substrate, and a portion for capturing the sample. The sample is then provided for capture by the amphifunctional molecule.

### CROSS-REFERENCE TO RELATED APPLICATIONS

The present application claims priority from Australian Provisional Patent Application No 2006905605 filed on 9 Oct. 2006, the content of which is incorporated herein by reference.

### TECHNICAL FIELD

The present invention relates to magnetic field detection, and in particular relates to positioning magnetically detectable samples at a desired location for detection by a magnetic field sensor.

### BACKGROUND OF THE INVENTION

Superconducting quantum interference devices (SQUIDs) are seeing increasing use as highly sensitive magnetic field sensors. Such SQUID sensors are becoming increasingly popular due to the capabilities of high sensitivity sensing in areas such as geophysical mineral prospecting and biological magnetic field detection.

Recent work has commenced on utilising SQUIDs for measurement of very small magnetic systems or samples such as nanoparticles, with a view to measurement of single-spin systems such as a single atom. In this field of application it has proved necessary to minimize the lateral scale and the inductance of the SQUID loop itself. It has been estimated that, in principle, a SQUID loop of about 1 μm in diameter could be used to detect a change in spin of a single electron. However, with decreasing size of the sample to be measured, and decreasing size of the active area of the SQUID loop, positioning of the sample in a suitable location to be detected by the SQUID becomes a substantial issue.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a method of positioning a sample at a desired location relative to a magnetic sensor for measurement of magnetic characteristics of the sample, the method comprising:
providing a sample mounting substrate;
binding an amphifunctional molecule to the sample mounting substrate at the desired location, the amphifunctional molecule having a portion for binding to the sample mounting substrate, and a portion for capturing the sample; and
providing the sample for capture by the amphifunctional molecule.

According to a second aspect the present invention provides a device for measurement of magnetic characteristics of a sample, the device comprising:
a magnetic sensor;
a sample mounting substrate; and
at least one amphifunctional molecule bound to the sample mounting substrate at a desired location relative to the magnetic sensor, the amphifunctional molecule having a portion for binding to the sample mounting substrate, and a portion having captured the sample.

The sample mounting substrate may comprise a resistive layer formed over the magnetic sensor. For example, the sample mounting substrate may comprise a gold (Au) layer deposited over a superconducting Nb layer defining a SQUID loop serving as the magnetic sensor. The gold layer may also serve as a resistive shunt to prevent hysteresis in Josephson junctions of the superconducting layer.

The portion of the amphifunctional molecule for binding to the sample mounting substrate may be bound by the electrochemical desorption mechanism. The portion of the amphifunctional molecule for binding to the sample mounting substrate may comprise sulfur to bind to the gold by chemisorption. An electrostatic or covalent or other bond may bind the amphifunctional molecule to the substrate.

The portion for capturing the sample preferably comprises a leaving group, which is dislodged from the amphifunctional molecule upon capture of the sample. For example the leaving group may comprise succinimide or an activated carboxyl group. The sample preferably comprises a nucleophile to dislodge the leaving group when the sample meets the amphifunctional molecule. For example the nucleophile may comprise NH₂.

The amphifunctional molecule preferably comprises 3-mercaptopropionic acid (MPA). Preferably, a layer of MPA molecules are deposited to form a self-assembling monolayer (SAM). Other carboxyl terminated thiols with various molecular length (carbon chain) might alternatively be used. In preferred embodiments the amphifunctional molecule is selected in order to improve spin measurement, even if at the expense of electron transport from ferritin, and in particular selecting appropriate molecular length as longer molecular lengths will cause less conductance. Longer length molecules may also be advantageous in improving magnetic coupling between the sample and sensor.

Preferably, the amphifunctional molecule is positioned in the desired location by use of nanoshaving. Such embodiments recognise that such a technique allows an extremely small patch of amphifunctional molecules to be produced in an accurately controlled location, such as within the loop of a nano-SQUID.

The sample may be provided for capture by the amphifunctional molecule by manipulating the sample with a scanning tunnelling microscope or an atomic force microscope. Such embodiments recognise that it is possible to push a ferritin particle several hundred nm across a substrate by an atomic force microscope tip.

Additionally or alternatively, the sample may be provided for capture by the amphifunctional molecule by washing a solution containing the sample over the sample mounting substrate.

The sample mounting substrate is preferably substantially coplanar with a SQUID loop. The sample mounting substrate is preferably provided within the SQUID loop such that the sample may be positioned within the SQUID loop. Such embodiments of the invention recognise that a nano-scale SQUID loop is insensitive to ambient external fields, while being of suitable sensitivity to a magnetic sample thus positioned within the SQUID loop.

The sample mounting substrate may be provided within the SQUID loop and away from a nominal centre of the SQUID loop in order to improve magnetic coupling between the sample and the SQUID loop.

The SQUID is preferably operated in, or configured for operation in, an open loop mode. That is, rather than exploiting flux locked loop feedback techniques, the voltage of the SQUID loop is preferably directly measured. Such embodiments of the invention recognise that nano-samples produce flux variations which are small relative to Φ₀, and that the SQUID thus does not enter a periodic mode of operation in response to such flux variations. Thus the voltage output of the SQUID in response to such nano-sample induced flux variations may be directly measured.

The sample mounting substrate preferably comprises a material to which the amphifunctional molecule may bind electrostatically, covalently or non-covalently (such as hydrogen bond). Silver may be used as a substrate for SAMs of alkanethiolates. While silver oxidizes readily in air, it does however give high-quality SAMs with a simpler structure than gold. Copper may be appropriate because it is a common material for interconnects and as a seed layer for electrodes deposits, but it is even more susceptible to oxidation than silver. Bare surfaces of metals and metal oxides tend to adsorb adventitious organic materials readily because these adsorbates lower the free energy of the interface between the metal or metal oxide and the ambient environment. Self-assembled monolayers (SAMs) provide a convenient, flexible, and simple system with which to tailor the interfacial properties of metals, metal oxides, and semiconductors. SAMs are organic assemblies formed by the adsorption of molecular constituents from solution or the gas phase onto the surface of solids or in regular arrays on the surface of liquids (in the case of mercury and probably other liquid metals and alloys); the adsorbates organize spontaneously (and sometimes epitaxially) into crystalline (or semicrystalline) structures.

### BRIEF DESCRIPTION OF THE DRAWINGS

An example of the invention will now be described with reference to the accompanying drawings, in which:

FIG. 1 is a scanning electron microscope image of a nano-SQUID suitable for use in the present invention

FIG. 2 illustrates attachment of ferritin particles on a gold surface using a SAM; and

FIG. 3 is a plot of the electrochemical analysis of the ferritin particles attached by the SAMs on the Au thin film surface.

### DESCRIPTION OF THE PREFERRED EMBODIMENTS

FIG. 1 is a scanning electron microscopy image of a nano-SQUID 100 comprising two nanobridges 110 which define a diamond-shaped nano-SQUID hole 120. The nano-SQUID 100 of FIG. 1 comprises a superconducting niobium underlayer, and the Josephson junctions in the niobium layer of the nanobridges 110 are non-hysteretic due to the presence of a shunting Au overlayer. The shunting resistance of the Au overlayer is about 2Ω.

The thickness of the Nb and Au thin films were 20 and 25 nm respectively. The Au overlayer was used as an etching mask as well as a protective layer for the Nb film to prevent oxidation. Electron-beam lithography was used to pattern the nano-SQUID 100. The two nanobridges 110 have a width of around 70 nm, giving a total critical current of around 50 μA. The nano-SQUID has a hole 120 of size ˜200 nm×200 nm.

The desirability to place a magnetic sample within the very small nano-SQUID hole 120 is set out in International Patent Application No. PCT/AU2007/001234 by the present applicant entitled “Method and apparatus for nano-scale SQUID”, the content of which is incorporated herein by reference. Deposition of nano-scale spin systems upon the surface of a nano-SQUID 100 for magnetic field detection presents a substantial challenge. While the following discussion is in reference to this problem, the present invention may be of utility in other situations in which such difficulties arise.

Self-assembled monolayers (SAMs) are monomolecular layers which are spontaneously formed upon immersing a solid substrate into a solution containing amphifunctional molecules. A particularly attractive feature of SAMs is the molecular level control over the surfaces. It has been recognised that it is possible to attach horse-spleen ferritin on the Au thin film surface of a nano-SQUID using SAMs. The ferritin particle is an iron storage protein consisting of an organic protein cage and an antiferromagnetic core of ˜4500 Fe(III) ions. The iron oxyhydroxide (approximate formula 9Fe₂O₃.9H₂O) core is ˜70 Å diameter, surrounded by a protein shell of ˜120 Å. It is antiferromagnetic below 13 K and has a net spin of ˜200 spins per particle.

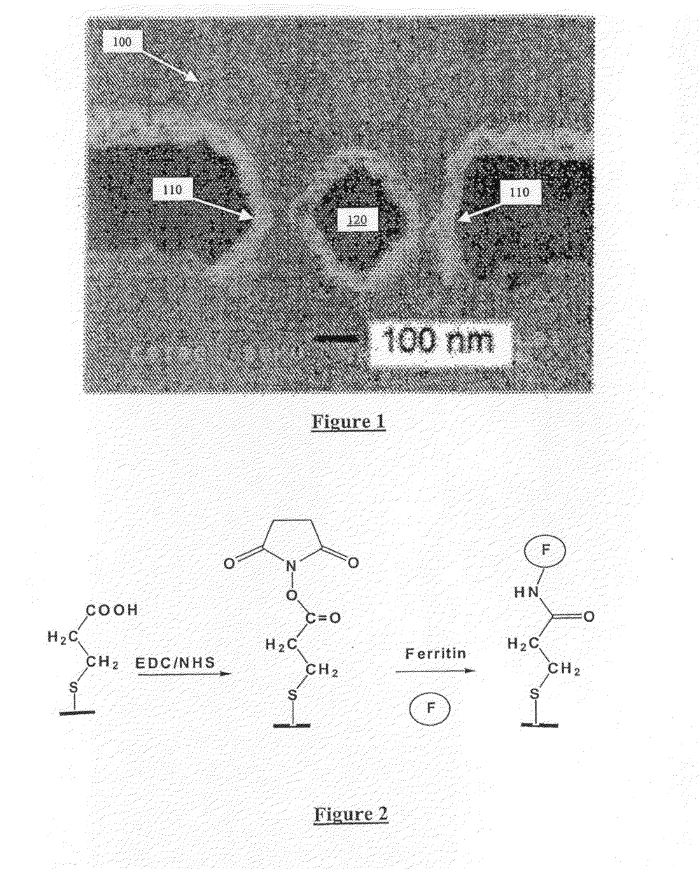

The attachment of ferritin particles on a gold surface was achieved using the SAMs as the link, as illustrated in FIG. 2, in which EDC stands for 1-ethyl(3-dimethylaminopropyl) carbodiimide hydrochloride, and NHS stands for N-hydroxysuccinimide. First, a MPA (3-mercaptopropionic acid) SAM was formed on the exposed Au surface through the electrochemical desorption mechanism. Then the protein cage of the ferritin particle was covalently attached to the activated carboxyl group of the MPA.

Attachment of the ferritin particle on the Au surface is achieved through the activated carboxyl group of the MPA (3-mercaptopropionic acid) SAM molecules. The carboxyl groups were activated by placing the gold electrodes with 75 mM 1-ethyl-3-(3-dimethylaminopropyl) carbodiimide (EDC) (Sigma, Sydney) and 50 mM N-hydroxysuccinimide (NHS) (Sigma, Sydney) in 50 mM phosphate buffer, pH 6.8 for 30 min.

The molecule attachment was confirmed by electrochemical analysis. The electrochemical measurements were performed with a BAS-100B electrochemical analyzer (ADI Instrument, Sydney) and a conventional three-electrode system comprising a bare or modified working electrode, a platinum foil as the auxiliary and an Ag|AgCl|3.0 M NaCl electrode (from BAS) as the reference.

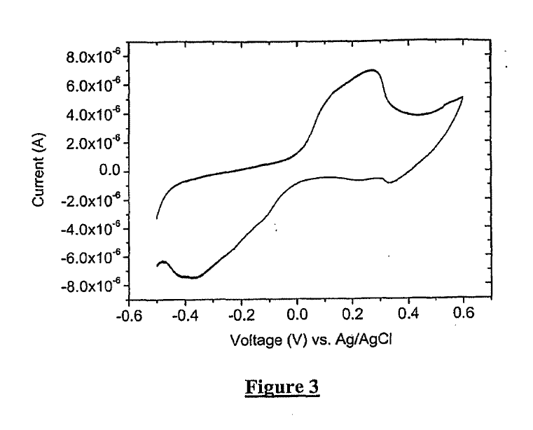

The electrochemical analysis of the ferritin particles on the Au thin film surface is illustrated by cyclic voltammograms of a gold electrode attached with ferritin in PB buffer, shown in FIG. 3. The peak at 0.25 V and the dip at −0.38 V indicate the oxidization of Fe(II) to Fe(III) and the reduction of Fe(III) to Fe(II) respectively.

The present invention further recognises that, by using the technique of nanoshaving, it is possible to control the size, shape and position of the SAM precisely on the nano-SQUID Au surface and therefore, it is feasible to attach a small number of ferritin and other similar organic particles and molecules on the sensitive area of the nano-SQUID for spin measurements. It should be noted that the position of the nanoparticles can be manipulated using either scanning tunneling microscopy or an atomic force microscope (AFM), as a ferritin particle can be pushed a few hundred nanometers using an atomic force microscope (AFM) tip.

Thus, such self assembly monolayers provide selective attachment of magnetically detectable molecules to the gold surface.

The present embodiment of the invention is described for use in conjunction with the nano-SQUID and method of operation thereof set out in PCT/AU2007/001234 by the present applicant.

Further, by providing the present technique for placement of a sample to within a few microns accuracy, the present invention allows the nano-SQUID hole to be made small and thus be made relatively insensitive to the static field. As the static field determines the frequency of the NMR signal, a larger static field range allows a broader detection bandwidth and hence, a larger number of different elements with different precession frequencies can be detected at the same time.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of positioning a sample at a desired location relative to a magnetic sensor for measurement of magnetic characteristics of the sample, the method comprising:
providing a sample mounting substrate;
binding an amphifunctional molecule to the sample mounting substrate at the desired location, the amphifunctional molecule having a portion for binding to the sample mounting substrate, and a portion for capturing the sample; and
providing the sample for capture by the amphifunctional molecule.

2. (canceled)

3. The method of claim 1 wherein the sample mounting substrate comprises a gold (Au) layer deposited over a superconducting niobium (Nb) layer defining a SQUID loop serving as the magnetic sensor.

4. (canceled)

5. (canceled)

6. (canceled)

7. The method of claim 1 wherein the portion of the amphifunctional molecule for binding to the sample mounting substrate is sulphur, to bind to the gold by chemisorption.

8. The method of claim 1 wherein the portion for capturing the sample comprises a leaving group to be dislodged from the amphifunctional molecule upon capture of the sample.

9. (canceled)

10. (canceled)

11. The method of claim 4 wherein the sample comprises a nucleophile to dislodge the leaving group when the sample meets the amphifunctional molecule.

12. (canceled)

13. The method of claim 1 wherein the amphifunctional molecule comprises 3-mercaptopropionic acid (MPA).

14. The method of claim 1 wherein the amphifunctional molecule comprises a layer of 3-mercaptopropionic acid MPA molecules that are deposited to form a self-assembling monolayer (SAM).

15. The method of claim 1 wherein the or each amphifunctional molecule is positioned in the desired location by use of nanoshaving.

16. The method of claim 1 wherein the sample is provided for capture by the amphifunctional molecule by any one of the following: i) manipulating the sample with a scanning tunnelling microscope; ii) manipulating the sample with an atomic force microscope; or iii) washing a solution containing the sample over the sample mounting substrate.

17. (canceled)

18. (canceled)

19. The method of claim 1 wherein the magnetic sensor is a nano-SQUID and the sample mounting substrate is provided within the SQUID loop such that the sample may be positioned within the SQUID loop.

20. (canceled)

21. A device for measurement of magnetic characteristics of a sample, the device comprising:
a magnetic sensor;
a sample mounting substrate; and
at least one amphifunctional molecule bound to the sample mounting substrate at a desired location relative to the magnetic sensor, the amphifunctional molecule having a portion for binding to the sample mounting substrate, and a portion binding the sample.

22. (canceled)

23. The device of claim 21 wherein the sample mounting substrate comprises a gold (Au) layer deposited over a superconducting niobium (Nb) layer defining a SQUID loop serving as the magnetic sensor.

24. (canceled)

25. (canceled)

26. (canceled)

27. The device of claim 23 wherein the portion of the amphifunctional molecule for binding to the sample mounting substrate is sulphur, bound to the gold by chemisorption.

28. The device of claim 21 wherein the sample comprises a nucleophile binding the sample to the amphifunctional molecule.

29. (canceled)

30. The device of claim 21 wherein the amphifunctional molecule comprises 3-mercaptopropionic acid (MPA).

31. The device of claim 30 wherein the amphifunctional molecule comprises a layer of 3-mercaptopropionic acid MPA molecules that are deposited to form a self-assembling monolayer (SAM).

32. The device of claim 21 wherein the magnetic sensor is a nano-SQUID, and wherein the sample mounting substrate and the sample are positioned within the SQUID loop.

33. The device of claim 32 wherein the sample mounting substrate is provided away from a nominal centre of the SQUID loop in order to improve magnetic coupling between the sample and the SQUID loop.

34. A device for measurement of magnetic characteristics of a sample to be captured, the device comprising:
a magnetic sensor;
a sample mounting substrate; and
at least one amphifunctional molecule bound to the sample mounting substrate at a desired location relative to the magnetic sensor, the amphifunctional molecule having a portion for binding to the sample mounting substrate, and a portion for capturing the sample.

35. The device of claim 34 wherein the portion for capturing the sample comprises a leaving group to be dislodged from the amphifunctional molecule upon capture of the sample.

36. (canceled)

37. (canceled)

38. The device of claim 34 wherein the amphifunctional molecule comprises 3-mercaptopropionic acid (MPA).

39. The device of claim 34 wherein the amphifunctional molecule comprises a layer of 3-mercaptopropionic acid (MPA) molecules that are deposited to form a self-assembling monolayer (SAM).

40. The device of claim 34 wherein the magnetic sensor is a nano-SQUID and the sample mounting substrate is provided within the SQUID loop such that the sample may be positioned within the SQUID loop.

41. The device of claim 40 wherein the sample mounting substrate is provided away from a nominal centre of the SQUID loop in order to improve magnetic coupling between the sample and the SQUID loop.
